(19) United States
(12) Patent Application Publication
(10) Pub. No.: US 2015/0090308 A1
(43) Pub. Date: Apr. 2, 2015

(54) WALKER ASSEMBLY AND METHOD OF USE TO ASSIST A SEATED PERSON TO RISE TO A STANDING POSITION

(71) Applicants: Remco Bos, Atlanta, GA (US); Craig Weaver, Crossville, TN (US)

(72) Inventors: Remco Bos, Atlanta, GA (US); Craig Weaver, Crossville, TN (US)

(21) Appl. No.: 14/039,078

(22) Filed: Sep. 27, 2013

(51) Int. Cl. A61H 3/04

(52) U.S. Cl. CPC A61H 3/04
USPC 135/67

(57) ABSTRACT

A walker assembly to assist a person in moving from a seated position to a standing position, including a frame having a base, the base being configured to support the walker assembly on a support surface and including a pair of opposed side members, and at least one stabilizer slidably received in one of the pair of opposed side members so that the at least one stabilizer is movable between a first position in which a distal end of the at least one stabilizer is disposed above the support surface and a second position in which the distal end of the stabilizer contacts the support surface.

### FIELD OF THE INVENTION

The present invention relates generally to medical devices. More particularly, the present invention relates to a device for assisting a person with limited physical capabilities to move from a seated position to a standing position, by oneself.

### BACKGROUND OF THE INVENTION

Many persons require assistance to stand from a seated position. Generally, these persons have a disability, are infirm because of age, are recovering from illness or surgical procedure, or have some other type of condition that limits their ambulatory capabilities. Certain methods and systems for assisting persons to stand from a seated position are known and available to such persons.

Of course, the most simple of these known methods likely is to physically lift the person without the aid of any devices. This method, though, has many shortcomings. Many persons who require standing assistance may not have available to them a person who is physically capable of lifting them from a seated position. Even where such a person is available, physical lifting often causes injury to the lifter because the lifter is required to lift too much weight or lift from an awkward position. Further, the infirm person receiving the lift also is at risk, as such lifting often causes skin tears and creates unstable situations that result in falls.

More complicated methods and systems also have been described. For example, a full body sling lift has been available for many years. Generally, these types of lifts are used for persons who have no weight bearing ability in their legs. While such devices may be useful in certain applications, they are difficult and time consuming to use. Further, these devices generally are not appropriate for persons who have some ambulatory capabilities and only require assistance to stand.

Sit/stand lifts also have been available in the market place for many years. A person who might benefit from this type of lift generally has upper arm strength and minimal weight bearing ability. The purpose of the sit/stand lift is to transfer a person from a sitting position to another sitting position or to the bed side. These types of lifts, however, are cumbersome and time consuming to use. As a result, a caregiver is tempted to manually help an infirm person to a standing position, which, as described above, may cause injury to the lifter or the person being lifted. A sit/stand lift also does not adequately meet the needs of the persons who only require help standing so that they may use a walker. Further, sit/stand lifts are often expensive, bulky, difficult to store, hard to maneuver in small areas, and difficult and time consuming to use.

Another option available to caregivers is a gate belt. Generally, a gate belt may be used to help a person attain a standing position so that they may use a walker or pivot to another sitting position. While gate belts may be effective for certain applications, they still tend to create an unstable situation during the lifting for the caregiver and person being lifted that leads to frequent falls and injuries. Further, the amount of weight the caregiver is required to lift is often unsafe and beyond Occupational Safety and Health Administration (“OSHA”) guidelines. The risk of injury is further heightened due to the twisting and ergonomically unsafe positioning that occurs during a gate belt lift.

The present invention recognizes and addresses considerations of prior art constructions and methods.

### SUMMARY OF THE INVENTION

One embodiment of a walker assembly in accordance with the present disclosure includes a frame having a base, the base being configured to support the walker assembly on a support surface and including a pair of opposed side members, and at least one stabilizer slidably received in one of the pair of opposed side members so that the at least one stabilizer is movable between a first position in which a distal end of the at least one stabilizer is disposed above the support surface and a second position in which the distal end of the stabilizer contacts the support surface.

Another embodiment of a walker assembly in accordance with the present disclosure includes a frame having a base, the base being configured to support the walker assembly on a support surface and including a pair of opposed side members, a pair of retractable stabilizers, each stabilizer being slidably received in a corresponding one of the pair of opposed side members so that each stabilizer is movable between a first position in which the stabilizer is disposed within the corresponding side member and a second position in which the stabilizer extends outwardly from the corresponding side member, and a horizontal member extending between and rigidly connecting the pair of stabilizers so that the pair of stabilizers move between the first position and the second position simultaneously.

Another embodiment of a walker assembly in accordance with the present disclosure includes a frame having a base and a front leg assembly, the base being configured to support the walker assembly on a support surface and including a pair of opposed side members, and the front leg assembly extending upwardly from the base, the front leg assembly including a pair of vertical members, each vertical member including a lifting bar disposed at its vertical end that is configured to be gripped by the person when moving to the standing position, a leg support slidably supported by the base of the frame, the leg rest being movable from a first position disposed a first distance from a rear end of the base to a second position disposed a second distance from the rear end of the frame, wherein the leg rest is configured to abut the person's legs when moving to the standing position and the first distance is greater than the second distance, and a pair of stabilizer, each stabilizers being slidably received in a corresponding one of the pair of opposed side members so that each stabilizer is movable between a first position in which the stabilizer is disposed within the corresponding side member and a second position in which the stabilizer extends outwardly from the corresponding side member.

A method of using a walker assembly of the present disclosure to move from a seated position to a standing position includes providing a frame having a base, the base being configured to support the walker assembly on a support surface and including a pair of opposed side members, providing a front leg assembly extending upwardly from the base, the front leg assembly including a pair of vertical members, each vertical member including a lifting bar disposed at its vertical end that is configured to be gripped by the person when moving to the standing position, providing a leg support slidably supported by the base of the frame, moving the leg support rearwardly from a first position disposed a first distance from a rear end of the base to a second position disposed a second distance from the rear end of the frame, wherein the leg support abuts the person's legs when in he second position, and grasping the lifting bars and pulling with the person's upper body as the person attempts to rise from the seated position to the standing position.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1A is a perspective view of a walker assembly in accordance with an embodiment of the present disclosure;

FIG. 1B is a perspective view of the walker assembly shown in FIG. 1A, with the stabilizers in the extended position;

FIG. 2A is a right side view of the walker assembly shown in FIG. 1A, with the stabilizers in the retracted position;

FIG. 2B is a right side view of the walker assembly shown in FIG. 1A, with the stabilizers in the retracted position;

FIGS. 3A through 3D are views of the walker assembly shown in FIG. 1A being used by a person of limited physical capabilities to move from a seated position to a standing position;

FIGS. 4A and 4B are partial, cut-away views of the walker assembly shown in FIGS. 2A and 2B, showing the stabilizers in the retracted and extended positions, respectively;

FIG. 5 is a partial perspective view of the locking ratchet mechanism of the walker assembly shown in FIG. 1A; and

FIG. 6 is a perspective view of a second embodiment of a walker assembly in accordance with the present disclosure.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

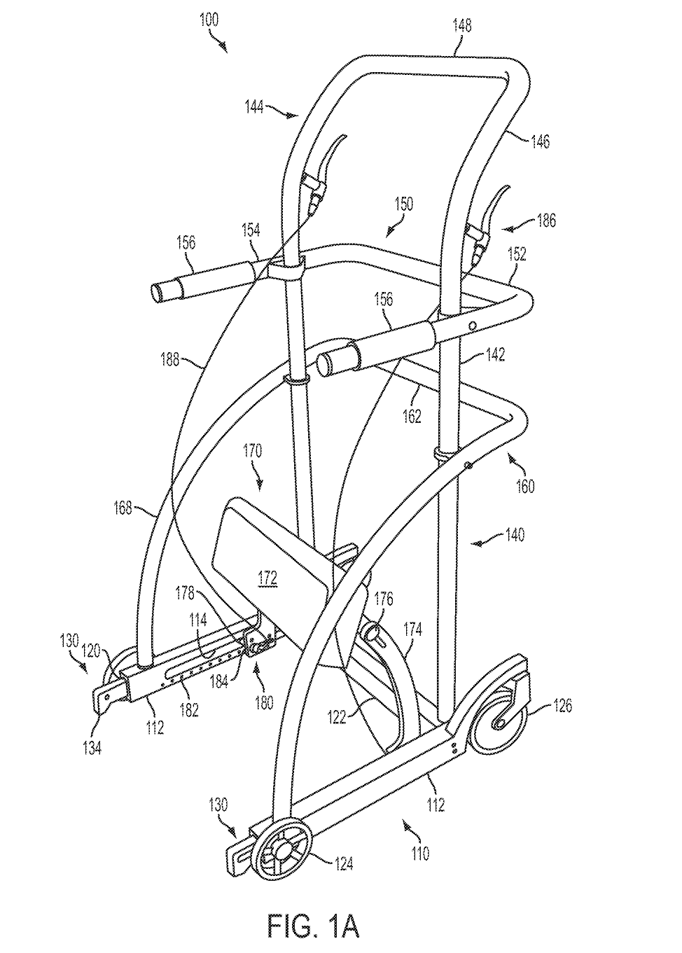

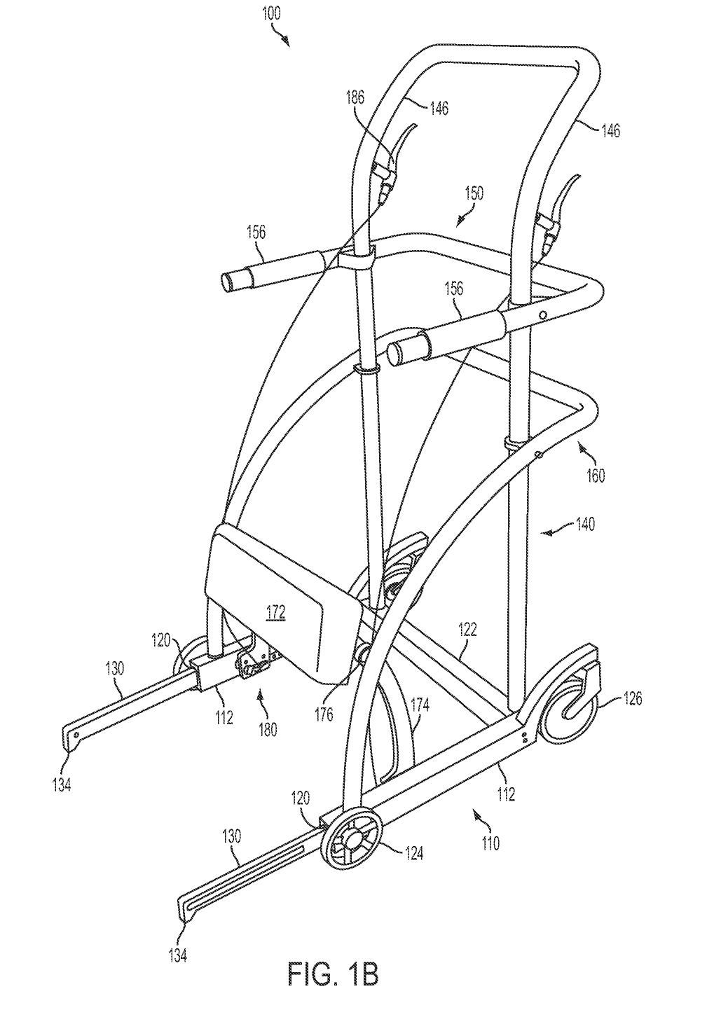

Referring now to FIGS. 1A and 1B, an embodiment of a walker assembly in accordance with the present disclosure includes a frame having a base 110, a pair of retractable stabilizers 130 slidably received in base 110, a leg support 170 slidably supported by the frame, and a locking ratchet assembly 180 for maintaining stabilizers 130 and leg support 170 in the desired positions, as discussed in greater detail below. Additionally, a pair of front wheels 126 and rear wheels 124 are secured to base 110 of the frame to increase mobility of walker assembly 100. Preferably, front wheels 126 are provided in the form of casters that further enhance mobility.

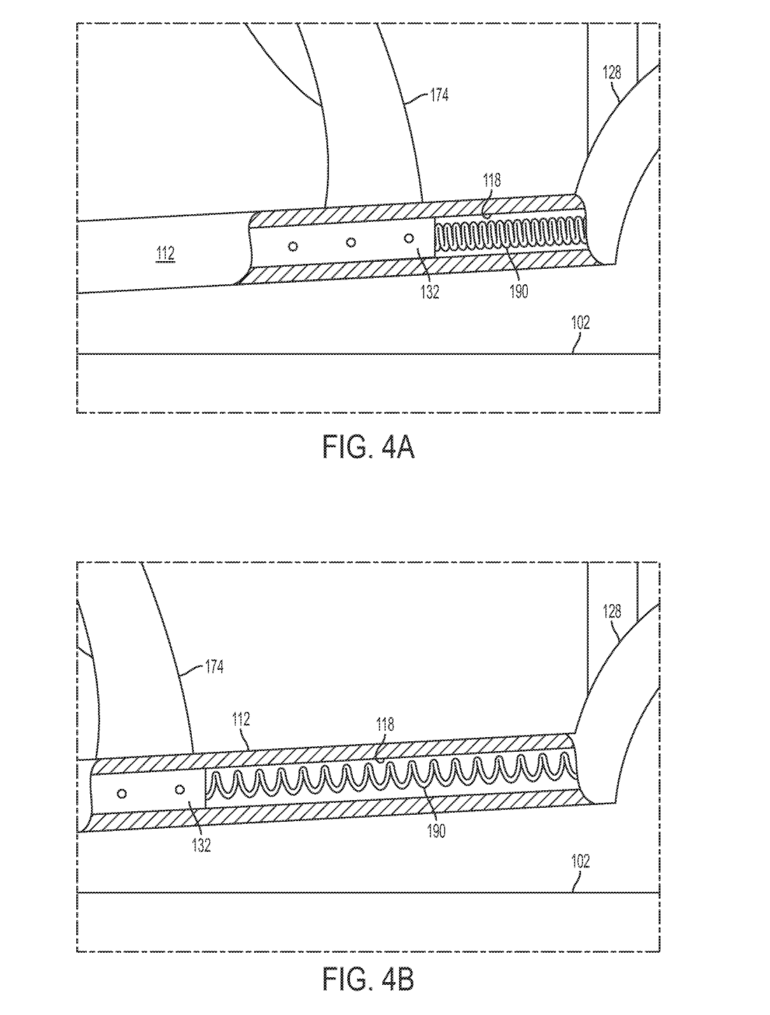

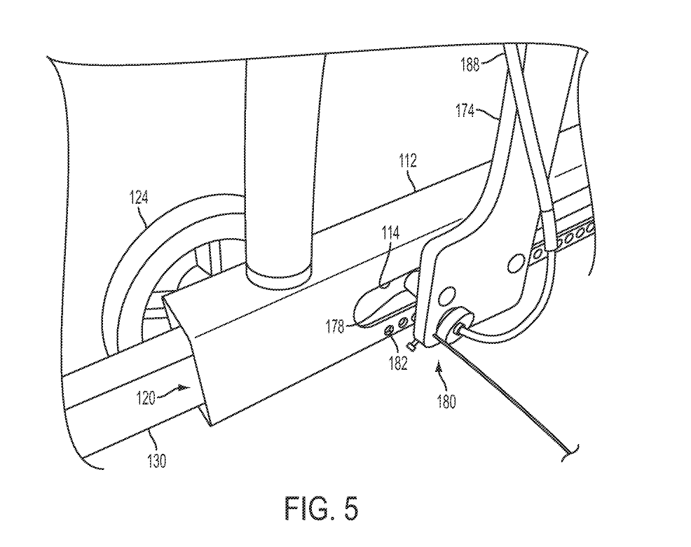

As shown, base 110 of the frame includes a pair of side members 112 that are substantially parallel and connected at their front ends by a front cross-member 122. Referring additionally to FIGS. 4A, 4B and 5, each side member 112 defines an elongated recess 118 having a rear opening 120. Each elongated recess 118 is configured to slidably receive a corresponding one of the pair of stabilizers 130. The inwardly-facing outer wall of each side member 112 further includes an elongated slot 114 and a plurality of recesses 182 formed therein. Elongated slots 114 allow stabilizers 130 to be secured to leg support 170 and recesses 182 are configured to selectively receive irretractable pin 184 of locking ratchet assembly 180, as discussed in greater detail below.

The frame of walker assembly 100 further includes a front leg assembly 140, a U-shaped handle member 150 and a support member 160. Front leg assembly includes a pair of vertical members 142 extending upwardly from a top surface of front cross-member 122 of base 110, and a U-shaped lifting bar 144 that connects the upper-most portions of vertical members 142. Preferably, lifting bar 144 includes a pair of curved vertical arms 146 that extend upwardly and curve forwardly from the corresponding vertical members 142, and are connected at their distal ends by a horizontal cross-member 148. Note, however, although vertical arms 146 in the present embodiment are curved, in alternate embodiments vertical arms 146 may be straight or curved in the rearward direction. As noted, handle member 150 is substantially U-shaped, and includes a front cross-member 152 and a pair of rearwardly extending side arms 154. Handle member 150 is affixed to front leg assembly 140 below lifting bar 144, and the distal end of each side arm 154 includes a hand grip portion 156. Support member 160 is provided to lend rigidity to the frame and includes curved side members 164 that extend upwardly from the rear portions of corresponding side members 112 and are secured to a corresponding vertical member 142 of front leg assembly 140. The front portions of curved side members 164 are connected by a front cross-member 162.

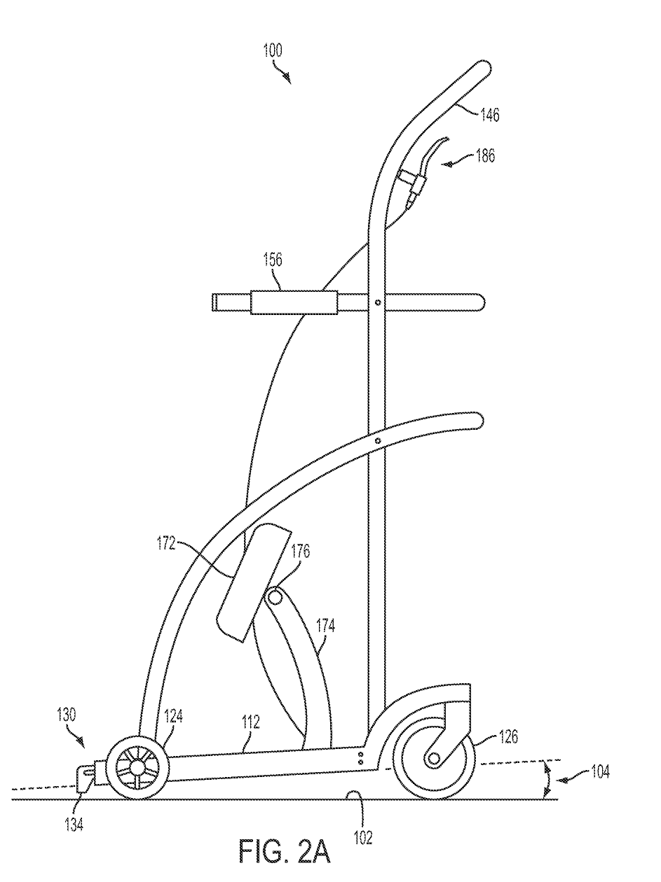

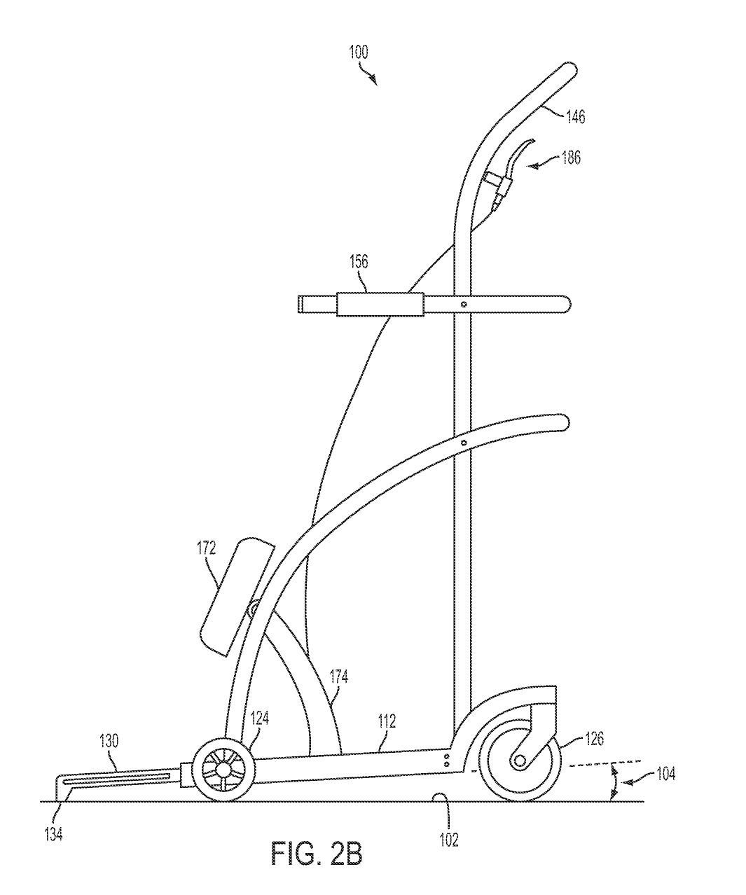

As previously noted, each retractable stabilizer 130 is slidably received in an elongated recess 118 of a corresponding side member 112 of base 110, as shown in FIGS. 4A and 4B. Additionally, each stabilizer includes a proximal end 132 that is disposed within the corresponding side member 112 and a distal end 134 which extends outwardly from the rear end of the corresponding side member 112 through rear opening 120. As shown in FIGS. 4A and 4B, proximal end 132 of each stabilizer 130 is preferably secured to a front portion of the corresponding side member 112 by a spring 190 or, in the alternative, by an elasticized band, hydraulic piston, etc. As such, each stabilizer 130 is biased into a first position in which the stabilizer is fully retracted into the corresponding side member 112, as shown in FIGS. 2A and 4A. However, stabilizers 130 are movable to a second position 130 in which the stabilizers are fully extended rearwardly from their corresponding side members 112, as shown in FIGS. 2B and 4B, by exerting rearward force on the stabilizers that overcomes the biasing force of springs 190. Note, in alternate embodiments, the stabilizers are not biased into the retracted position by springs but, instead, are manually returned to the retracted position by the user.

As best seen in FIGS. 2A and 2B, stabilizers 130 and their corresponding side members 112 are configured such that their longitudinal center axes form an angle 104 with a support surface 102 on which walker assembly 100 rests. As such, in the embodiment shown, when stabilizers 130 are in the first retracted position, distal ends 134 of stabilizers 130 do not make contact with support surface 102. However, angle 104 is selected such that as stabilizers 130 are moved rearwardly from the first retracted position to the second extended position, distal ends 134 of stabilizers 130 eventually make contact with support surface 102, as shown in FIG. 2B. In short, this configuration lengthens the fore-to-aft distance between points of contact of walker assembly 100 and support surface 102, thereby enhancing stability of the assembly.

Referring specifically to FIGS. 1A and 5, leg support 170 includes a pair of side arms 174 that are connected at their upper ends by a support axle 176, and they are connected at their lower ends to a corresponding stabilizer 130 by mounting shafts 178 that pass through the respective elongated slots 114. A pad 172 is pivotally received on support axle 176 so that the angle of pad 172 relative to a person's legs may be adjusted. Leg support 170 rigidly connects the pair of stabilizers 130 adjacent their front ends so that as leg support 170 is moved rearwardly from a first position to a second position, stabilizers 130 move simultaneously from the first retracted position to the second extended position.

As previously noted, locking ratchet assembly 180 includes a pair of retractable pins 180, each affixed to a bottom portion of a corresponding side arm 174 of leg support 170, and a plurality of recesses 182 formed on the inwardly-facing outer wall of each side member 112. Additionally, locking ratchet assembly 180 includes a pair of hand levers 186, each mounted to a corresponding vertical arm 146. Each lever 186 is remotely connected to a corresponding pin 184 by a cable 188. As previously noted, pins 184 and recesses 182 are configured so that leg support 170 may be moved from the first forward position to the second rearward position although pins 184 engage recesses 182, whereas motion of leg support 170 from the second rearward position to the first forward position is prevented by the engagement of pins 184 and recesses 182. A person may disengage pins 184 from the corresponding recesses 182 by operating one, or both, remote levers 186. Note, in alternate embodiments, locking ratchet assembly 180 may be replaced by locking pins that engage corresponding locking apertures formed in side members 212 and the corresponding stabilizers 130.

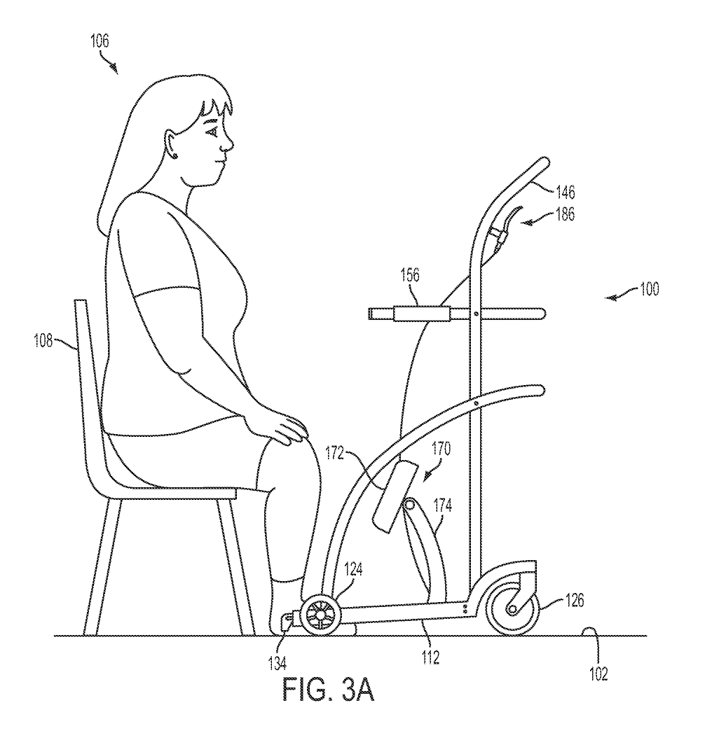

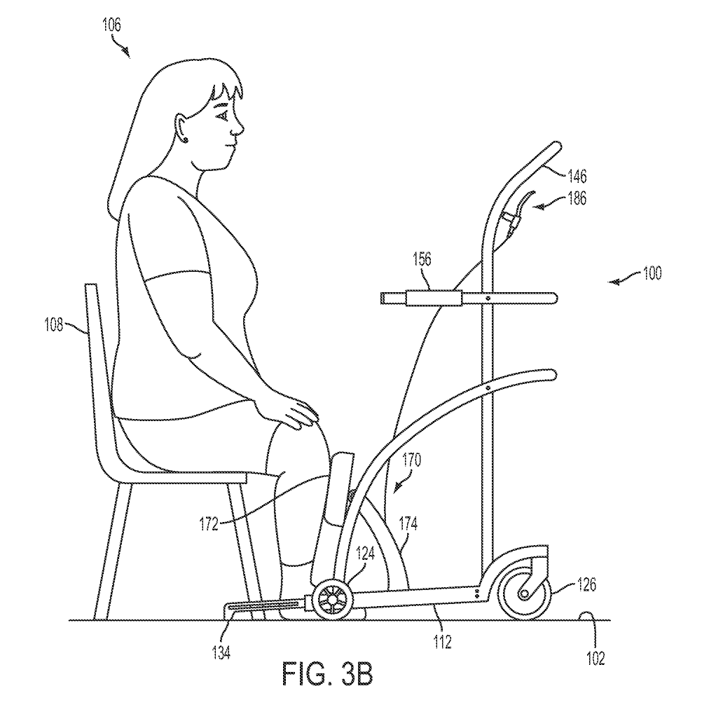

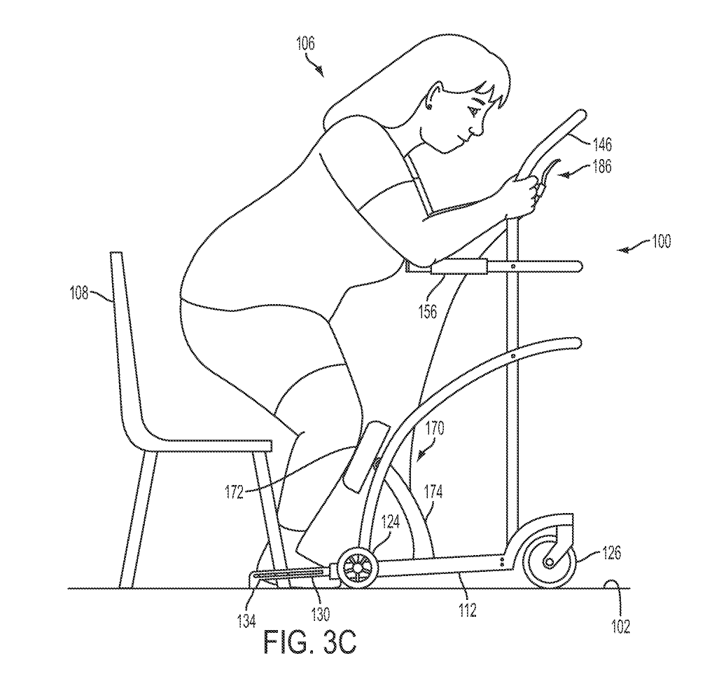

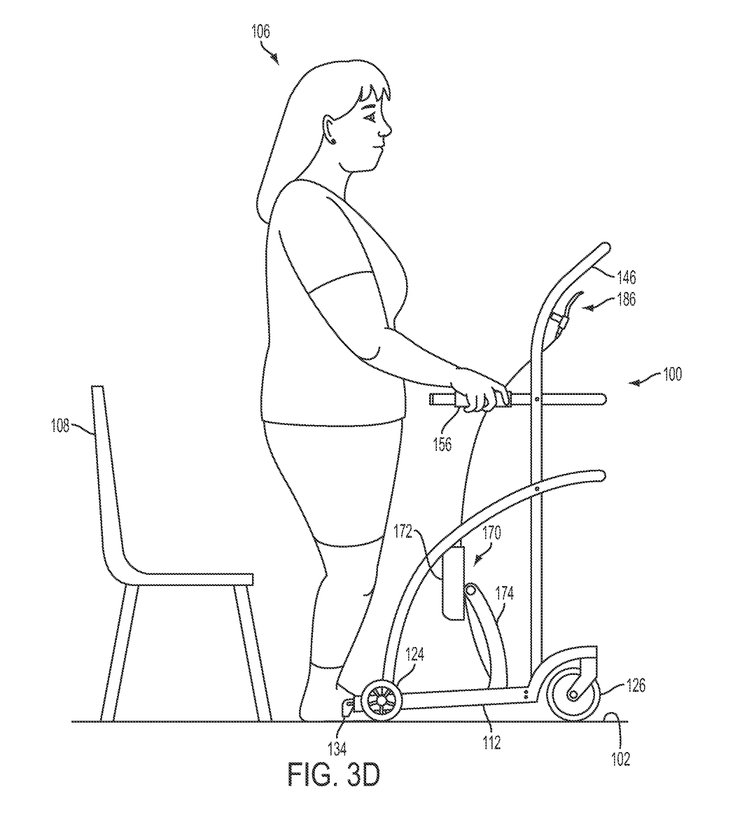

Referring now to FIGS. 3A through 3D, a method of utilizing walker assembly 100 to assist a person having limited physical capabilities is discussed. As shown in FIG. 3A, the person to be assisted is seated in a standard chair 108. Note, however, walker assembly 100 may also be used to assist person seated on couches, benches, mattresses, etc. First, the person pulls walker assembly 100 toward himself until his feet and lower legs are disposed between side members 112 of the base 100, as shown in FIG. 3A. Referring now to FIG. 3B, the person leans slightly forward and pulls leg support 170 rearwardly from the first position (FIG. 3A) to the second rearward position in which pad 172 of leg support 170 contacts the person's lower legs, preferably on the upper portion of the shins just below the knees. As the person pulls leg support 170 into contact with their legs, stabilizers 130 simultaneously extend rearwardly from their first retracted position (FIG. 3A) to their second fully extended position, as shown in FIG. 3B. As previously noted, for the embodiment shown, when stabilizers 130 are in the second fully extended position, distal ends 134 of stabilizers 130 make contact with support surface 102. Note, however, in alternate embodiments, the distal ends of stabilizers 130 need not make contact with support surface 102 in the fully extended position. As well, in other alternate embodiments, distal ends 134 of stabilizers 130 may be in contact with support surface 102 in both the fully retracted and fully extended positions.

Referring now to FIG. 3C, after positioning pad 172 of leg support 170, the person leans forward and grasps vertical arms 146 of front leg assembly 140. The person then pulls upwardly on vertical arms 146 with his upper body while simultaneously pushes upwardly with his lower body. Contact of pad 172 with the person's legs prevents rearward motion of walker assembly 100 relative to the person as the person moves from the seated to the upright position. Additionally, contact between pad 172 and the person's legs provide a leveraging point such that the person may utilize both their upper body and lower body musculature as they move to the standing position, without fear of undesired movement of walker assembly 100.

Referring now to FIG. 3D, upon reaching the standing position, the person operates a hand lever 186 of locking ratchet assembly 180 to disengage pins 184 from the corresponding recesses 182, thereby allowing springs 190 (FIGS. 4A and 4B) to automatically retract stabilizers 130 into the respective side members 112 of the base. Simultaneously, leg support 170 moves to the forward position and out of the way of the person's legs so the person may utilize walker assembly to move about.

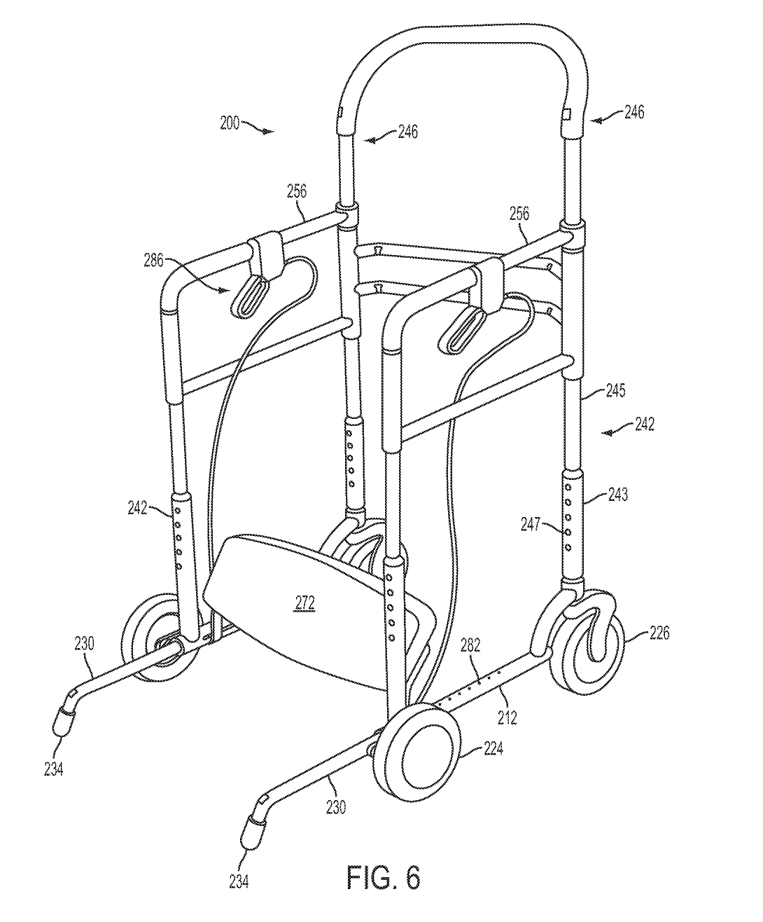

Referring now to FIG. 6, a second embodiment of a walker assembly 200 in accordance with the present disclosure is shown. Walker assembly 200 is similar to the previously discussed embodiment in many respects, and only the differences are discussed here. For example, vertical members 242 of the frame include an upper portion 245 that is telescopically received in sliding engagement with a lower portion 243. As such, the overall height of the frame may be adjusted dependent upon the height of the person utilizing walker assembly 200. Locking pins (not shown) are inserted into corresponding apertures 247 formed in lower and upper portions 243 and 245, respectively, to lock the frame at the desired height. Additionally, distal ends 234 of stabilizers 230 are configured such that they make contact with the support surface on which the walker assembly rests in both the first retracted position and second extended position. As such, base members 212 of the frame may be horizontal to the support surface on which walker assembly 200 rests.

While one or more preferred embodiments of the invention are described above, it should be appreciated by those skilled in the art that various modifications and variations can be made in the present invention without departing from the scope and spirit thereof. For example, in alternate embodiments, small electric motors could be utilized to extend and retract the stabilizers. It is intended that the present invention cover such modifications and variations as come within the scope and spirit of the appended claims and their equivalents.

What is claimed is:

1. A walker assembly to assist a person in moving from a seated position to a standing position, comprising:
a frame including a base, the base being configured to support the walker assembly on a support surface and including a pair of opposed side members; and
at least one stabilizer slidably received in one of the pair of opposed side members so that the at least one stabilizer is movable between a first position in which a distal end of the at least one stabilizer is disposed above the support surface and a second position in which the distal end of the stabilizer contacts the support surface.

2. The walker assembly of claim 1, wherein a longitudinal center axis of the at least one stabilizer forms an angle with the support surface.

3. The walker assembly of claim 2, wherein the longitudinal center axis of the at least one stabilizer is parallel to a longitudinal center axis of the one of the pair of opposed side members.

4. The walker assembly of claim 1, wherein in the first position the at least one stabilizer is extended rearwardly from the one of the pair of opposed side members and in the second position the at least one stabilizer is retracted inwardly into the one of the at least one side members.

5. The walker assembly of claim 1, wherein the at least one stabilizer further comprises a first stabilizer slidably disposed in a first of the pair of opposed side members and a second stabilizer disposed in a second of the pair of opposed side members.

6. The walker assembly of claim 5, wherein the first stabilizer and the second stabilizer are rigidly connected by a horizontal member so that they move between the first position and the second position simultaneously.

7. The walker assembly of claim 6, wherein the horizontal member further comprises a pad configured to abut a portion of the legs of the person when the first and second stabilizers are in the second position.

8. The walker assembly of claim 1, further comprising a locking ratchet assembly including a retractable pin affixed to the at least one stabilizer and a plurality of recesses configured to selectively receive the retractable pin disposed on the frame, wherein the locking ratchet assembly permits the stabilizer to move in a first direction from the first position to the second position as the pin alternatingly engages various recesses of the plurality of recesses, yet prevents the stabilizer from moving in a second direction from the second position to the first position while the retractable pin engages the plurality of recesses.

9. The walker assembly of claim 1, wherein the frame further comprises a front leg assembly extending upwardly from the base, the front leg assembly including a pair of vertical members, each vertical member including a lifting bar disposed at its vertical end that is configured to be gripped by the person when moving to the standing position.

10. The walker assembly of claim 1, wherein the at least one stabilizer is biased inwardly into the one of the pair of opposed side members by a biasing element.

11. The walker assembly of claim 10, wherein the biasing element is a spring.

12. A walker assembly to assist a person in moving from a seated position to a standing position, comprising:
a frame including a base, the base being configured to support the walker assembly on a support surface and including a pair of opposed side members;
a pair of retractable stabilizers, each stabilizer being slidably received in a corresponding one of the pair of opposed side members so that each stabilizer is movable between a first position in which the stabilizer is disposed within the corresponding side member and a second position in which the stabilizer extends outwardly from the corresponding side member; and
a horizontal member extending between and rigidly connecting the pair of stabilizers so that the pair of stabilizers move between the first position and the second position simultaneously.

13. The walker assembly of claim 12, wherein a longitudinal center axis of each stabilizer forms an angle with the support surface so that a distal end of each stabilizer is disposed above the support surface in the first position and contacts the support surface in the second position.

14. The walker assembly of claim 13, wherein the longitudinal center axis of each stabilizer is parallel to a longitudinal center axis of the corresponding side member.

15. The walker assembly of claim 12, wherein the horizontal member further comprises a pad configured to abut a portion of the legs of the person when the pair of stabilizers is in the second position.

16. The walker assembly of claim 12, further comprising a locking ratchet assembly including a retractable pin disposed on the horizontal member and a plurality of recesses configured to selectively receive the retractable pin disposed on the base of the frame, wherein the locking ratchet assembly permits the stabilizer to move in a first direction from the first position to the second position as the pin alternatingly engages various recesses of the plurality of recesses, yet prevents the stabilizer from moving in a second direction from the second position to the first position while the retractable pin engages the plurality of recesses.

17. The walker assembly of claim 12, wherein the frame further comprises a front leg assembly extending upwardly from the base, the front leg assembly including a pair of vertical members, each vertical member including a lifting bar disposed at its vertical end that is configured to be gripped by the person when moving to the standing position.

18. A walker assembly to assist a person in moving from a seated position to a standing position, comprising:
a frame including a base and a front leg assembly, the base being configured to support the walker assembly on a support surface and including a pair of opposed side members, and the front leg assembly extending upwardly from the base, the front leg assembly including a pair of vertical members, each vertical member including a lifting bar disposed at its vertical end that is configured to be gripped by the person when moving to the standing position;
a leg support slidably supported by the base of the frame, the leg support being movable from a first position disposed a first distance from a rear end of the base to a second position disposed a second distance from the rear end of the frame, wherein the leg support is configured to abut the person's legs when moving to the standing position and the first distance is greater than the second distance; and
a pair of stabilizers, each stabilizer being slidably received in a corresponding one of the pair of opposed side members so that each stabilizer is movable between a first position in which the stabilizer is disposed within the corresponding side member and a second position in which the stabilizer extends outwardly from the corresponding side member.

19. The walker assembly of claim 18, wherein a longitudinal center axis of each stabilizer forms an angle with the support surface so that a distal end of each stabilizer is disposed above the support surface in the first position and contacts the support surface in the second position.

20. The walker assembly of claim 18, wherein the longitudinal center axis of each stabilizer is parallel to a longitudinal center axis of the corresponding side members.

21. The walker assembly of claim 18, further comprising a locking ratchet assembly including a retractable pin disposed on the leg rest and a plurality of recesses disposed on the base of the frame configured to selectively receive the retractable pin, wherein the locking ratchet assembly permits the leg support to move in a first direction from the first position to the second position as the pin alternatingly engages various recesses of the plurality of recesses, yet prevents the leg support from moving in a second direction from the second position to the first position while the retractable pin engages the plurality of recesses.

22. A method of assisting a person in moving from a seated position to a standing position with a walker assembly, comprising:
providing a frame including a base, the base being configured to support the walker assembly on a support surface and including a pair of opposed side members;
providing a front leg assembly extending upwardly from the base, the front leg assembly including a pair of vertical members, each vertical member including a lifting bar disposed at its vertical end that is configured to be gripped by the person when moving to the standing position;
providing a leg support slidably supported by the base of the frame;
moving leg support rearwardly from a first position disposed a first distance from a rear end of the base to a second position disposed a second distance from the rear end of the frame, wherein the leg support abuts the person's legs when in the second position; and
grasping the lifting bars and pulling with the person's upper body as the person attempts to rise from the seated position to the standing position.

23. The method of claim 22, further comprising:
providing a pair of stabilizers, each stabilizer being slidably received in a corresponding one of the pair of opposed side members; and
moving the pair of stabilizers from a first position in which the stabilizers are disposed within the corresponding side members to a second position in which the stabilizers extend outwardly from the corresponding side members, wherein the pair of stabilizers move from the first position to the second position simultaneously to the leg support moving from the first position to the second position.
